(19) United States
(12) Patent Application Publication
(10) Pub. No.: US 2012/0028031 A1
(43) Pub. Date: Feb. 2, 2012

(54) IRON-BASED SINTERED MATERIAL

(75) Inventors: Shizuka YAMAGUCHI, Hitachinaka (JP); Kazutaka Okamoto, Tokai (JP); Noboru Baba, Hitachiota (JP); Yuji Yamanishi, Kashiwa (JP); Tadayuki Tsutsui, Matsudo (JP)

(73) Assignee: HITACHI, LTD.

(21) Appl. No.: 13/186,589

(22) Filed: Jul. 20, 2011

(30) Foreign Application Priority Data
Jul. 28, 2010 (JP) 2010-168781

(51) Int. Cl. B32B 3/26

(52) U.S. Cl. 428/319.1

(57) ABSTRACT

The present invention provides an iron-based sintered material in which a rolling contact fatigue strength is improved. In an iron-based sintered material used in such an environment that a lubricating oil is sufficiently fed, a hard carbon coating is provided on a surface of a base material constructed by an iron-based sintered material alloy having a pore via a surface layer hardened by diffusion and an interlayer, and a part of the pore is not covered with the surface layer hardened by diffusion, the interlayer and the hard carbon coating, but is formed in a state of being open to the surface of the surface layer hardened by diffusion.

### BACKGROUND OF THE INVENTION

(1) Field of the Invention

The present invention relates to an iron-based sintered material in which a high rolling contact fatigue strength is demanded.

(2) Description of related art

A powder-metallurgy processing is a technique of firmly binding powder particles so as to manufacture a metal product by fixing a raw material powder made of the metal powders or the like to predetermined shape and dimension and heating it at a temperature at which it does not melt, and is generally constructed by a mixing step of mixing the metal powders or the like at a predetermined ratio so as to regulate the raw material powder, a forming step of compacting the raw material powder obtained by the mixing step, and a sintering step of sintering the compacted product obtained by the forming step. In accordance with the powder-metallurgy processing mentioned above, it is possible to form in a near net shape, and on the basis of such features that it is suited for a mass production and a special material which can not be obtained by an ingot metallurgy processing can be manufactured, an application to an automotive machine part such as various gears or sprockets (a chain sprocket wheel) or the like, and various industrial machine parts such as a rotor and a vane of an oil pump and the like has been made progress.

In the sintered material mentioned above, since a powder is formed in an inner portion on the basis of a manufacturing method, a strength is low in comparison with the ingot material, however, a strength of a sintered material has been enhanced and the application to the various machine parts mentioned above has been made progress, by giving a lot of alloy components to the sintered material so as to reinforce a base material by an alloy element (patent documents 1 and 2), or by enhancing a partial density or a whole density of the sintered material and reducing an amount of the pore, where a crack may initiate, to enhance a strength of the base material (patent documents 3 to 5).

Patent Document 1: JP-A-03-120336

Patent Document 2: JP-A-09-087794

Patent Document 3: JP-A-11-125324

Patent Document 4: JP-A-2007-262536

Patent Document 5: JP-A-2001-513143

These automotive machine parts and the various industrial machine parts have been exposed to a higher load than the conventional ones under a recent demand of a weight saving and a high output or performance, and a high rolling contact fatigue strength which can stand up to a high load has been demanded.

In order to improve the rolling contact fatigue strength of the sintered material, it is effective to enhance the strength of the sintered material as mentioned above, however, an addition of a lot of alloy components is not expedient since an increase of a cost is enlarged on the basis of an appreciation of the alloy element in recent years. Further, a certain degree of higher density can be achieved by applying a two-step compacting and two-step sintering method, a warm compacting, a forging or a form rolling, however, it is hard to do away with the pore which may initiate breaking. On the other hand, an energy required for a high density is great in any method, and a cost increase is caused by adding these steps.

### BRIEF SUMMARY OF THE INVENTION

On the basis of these matters, there is desired a sintered material in which a rolling contact fatigue strength is improved without depending on a method of enhancing a strength of the sintered material.

An iron-based sintered material in accordance with the present invention solving the problem mentioned above is an iron-based sintered material used in such an environment that a lubricating oil is sufficiently fed, wherein a hard carbon coating is provided on a surface of a base material constructed by an iron-based sintered material alloy having a pore via a surface layer hardened by diffusion and an interlayer, and a part of the pore is not covered with the surface layer hardened by diffusion, the interlayer and the hard carbon coating, but is formed in a state of being open to the surface of the surface layer hardened by diffusion. Further, in the iron-based sintered material in accordance with the present invention, it is preferable that the hard carbon coating has an indentation hardness between 23 and 41 GPa, a porosity of the surface of the hard carbon coating is between 5 and 15%, the hard carbon coating is constructed by a DLC, the interlayer is at least one kind selected from Si, Cr, Ti, W, TiC and WC, and the surface layer hardened by diffusion is constructed by any one of a carbonization-quenched layer, a nitride layer, a nitrocarburized layer and a carburized nitride layer.

### Effect of the Invention

In the iron-based sintered material in accordance with the present invention, since the hard carbon coating having a low coefficient of friction is formed on a most front surface, and the pore open to the most front surface is provided as a local reservoir which lubricates oil on a sliding surface as well as a lubrication is held in this pore, a slip with respect to the other member is generated. As a result, a stress concentration is reduced and an improvement of a rolling contact fatigue strength is achieved.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWING

FIG. 1 is a cross sectional schematic view of an iron-based sintered material in accordance with the present invention;

FIG. 2 is a photograph substituting for a drawing showing a surface aspect of the iron-based sintered material which is coated with a DLC;

FIG. 3 is a photograph substituting for a drawing showing a cross sectional structure aspect of the iron-based sintered material which is coated with the DLC;

FIG. 4 is a schematic view showing an outline of a roller pitching test; and

FIG. 5 is a view showing a rolling contact fatigue strength of the iron-based sintered material which is coated with the DLC.

### DETAILED DESCRIPTION OF THE INVENTION

FIG. 1 is a cross sectional schematic view of an iron-based sintered material in accordance with the present invention.

In the present drawing, the iron-base sintered material is provided with a coating sheet which is constructed by a surface layer hardened by diffusion 3, an interlayer 2 and a hard carbon coating 1 toward an outer side from a base material 4, and is formed such an aspect that a pore 5 of the base material is open so as to form a discontinuous surface layer.

The base material 4 employs an iron-based sintered body while taking a strength into consideration.

The surface layer hardened by diffusion 3 is constructed by any one of a carbonization-quenched layer which is treated at a high temperature in an austenite region and in which a deep quench-hardened layer is formed, and a nitride layer, a nitrocarburized layer and a carburized nitride layer which are treated at a lower temperature region than it and in which a deformation or the like of the base material is small and a thin quench-hardened layer is formed, and is selected in the light of a load capacity caused by a load stress.

The interlayer 2 is a coating sheet such as a metal or the like which is formed in the midpoint of the hard carbon coating 1 and the surface layer hardened by diffusion 3, and avoids a formation of an interface and a stress concentration caused by dissimilar materials mismatch. The interlayer 2 has an operation and effect of enhancing an adhesion of the hard carbon coating 1 by reinforcing an interface of the hard carbon coating 1 and the surface layer hardened by diffusion 3, reducing a high compression internal stress of the hard carbon coating 1 itself, improving a base material rigidity or the like. In the interlayer 2 mentioned above, a brittle chemical compound is formed in the hard carbon coating 1, hence a cracking is generated along with the chemical compound. Accordingly, it is desirable that the brittle chemical compound is not formed, and it is suitable to employ at least one kind which is selected from Si, Cr, Ti, W, TiC and WC, in this regard.

The pore 5 is not covered and closed by the coating sheet of the interlayer 2 and the hard carbon coating 1, but is open. In accordance with this aspect, the lubricating oil makes an intrusion into the pore 5 in such a sliding environment that the lubricating oil is sufficiently fed, and the lubricating oil reserved in the pore at a time of sliding is fed to the slide surface so as to contribute to a reduction of a friction with the other member, as well as an oil keeping effect can be obtained. In order to obtain this effect, it is desirable that a porosity which is open to the surface of the hard carbon coating is set to be equal to or more than 5%. Further, in order to make the porosity which is open to the surface of the hard carbon coating equal to or more than 5% as mentioned above, it is desirable to make a porosity of the base material equal to or more than 5%. On the other hand, if an amount of the pore of the base material 4 constructed by the iron-based sintered body is increased, the strength of the base material 4 is lowered and the strength of the iron-based sintered member is lowered. If the porosity of the base material 4 becomes more than 15%, the reduction of the strength becomes significant. At this time, the porosity which is open to the surface of the hard carbon coating comes to 15%.

The hard carbon coating 1 is preferably constructed by a diamond like carbon (DLC). The DLC is an amorphous material which is constructed by a carbon and a hydrogen, and its micro structure is determined by abundance ratios of sp³ and sp² and a hydrogen content. A glassy C, a sputtered a-C (amorphous carbon), a ta-C (tetrahedral amorphous carbon), an a-C:H (hydrogenated amorphous carbon) and a ta-C:H (hydrogenated tetrahedral amorphous carbon) exist in a metastable structure of an amorphous carbon, and four kinds of metastable structures except the glassy C are called as the DLC. If the hydrogen content goes beyond about 60 at %, it forms a polymeric state so as to become brittle, and if it becomes further more, a membrane as a solid state is not formed. A hardness of the DLC depends greatly on the micro structure, and a wide value up to 1000 to 8000 HV has been reported. The coefficient of friction changes in accordance with the sliding environment, however, indicates a low value about 0.1 in all the metastable structures. This is because the most front surface transfers to a structure which is similar to sp2 by the slide motion, and expresses a self lubricating characteristic which is similar to a graphite.

As a membrane forming method of the DLC membrane, there are various methods, for example, a sputtering method (UBMS: unbalanced magnetron sputtering), a plasma CVD (chemical vapor deposition) method, an arc ion plating method and the like.

Generally, in a slide surface which comes into rolling contact or slide contact such as a tooth surface of a gear or the like, a stress becomes maximum at a position slightly heading for an inner portion from a front surface not on the front surface, and a starting point of a fatigue failure is generated at the position slightly heading for the inner portion from the front surface, however, in the iron-based sintered material in accordance with the present invention, since the hard carbon coating having the low coefficient of friction is formed on the most front surface, and the lubricating oil feed is achieved on the slide surface as well as having the pore which is open to the most front surface and keeping the lubrication in this pore, the effect of reducing a shear stress on the basis of a reduction of the coefficient of friction and reducing a local heat generation prevents a reduction of an actual surface pressure and a micro reduction of a material strength, so that an improvement of a surface pressure fatigue strength is achieved.

### Embodiment

Table 1 shows a kind of the DLC coating which is made a study by the present invention. (1) and (2) are UBMS of a sputter ring, and since an ion assist effect is increased by enhancing a plasma density in the vicinity of a base plate in accordance with a non-parallel magnetic field, and an energy of an ion which is attracted to the base plate by a bias voltage at a time of forming a membrane so as to come into collision is increased, it is possible to obtain a DLC membrane which is dense and has a high adhesion force.

(3) is a combination with P-CVD in which the DLC is excellent in a smoothness and achieves an efficiency, after forming an interlayer enhancing an adhesion by the UBMS.

(4) is structured such as to form a laminated mixed structure of a tungsten carbide and an amorphous carbon by a WC/C coating sheet by a sputtering, and is different from the DLC which is constructed only by the other amorphous carbon.

(5) is an AIP, and since an ionization rate is high by evaporating a solid carbon target by an arc discharge, a DLC membrane having a high hardness and is free of hydrogen is formed. However, since evaporated particles come to micro particles (including a lot of evaporated particles equal to or more than 10 μm) so as to be attached, a surface roughness is deteriorated. Accordingly, a lapping step of the surface is necessary after the coating.

(6) deflects the carbon plasma created by the arc discharge by the magnetic field so as to arrive at the base plate and form the membrane. Accordingly, a macro particle of a neutral particle does not arrive at the base plate, and a smooth DLC membrane is formed, thereby compensating for the disadvantage of the AIP. The hydrogen free ta-C DLC membrane which is similar to the AIP can be obtained. However, one or more questions exist in a scale increase of a treated product and a productivity of a three-dimensional treatment or the like on the basis of an apparatus structure of a magnetic field deflecting mechanism or the like.

Hereinafter, the DLC membrane is formed in accordance with the various membrane forming methods in Table 1 in the embodiments.

TABLE 1

| Kind of | Membrane forming | Kind of | Hardness | Surviving |
|---|---|---|---|---|
| DLC | method | membrane | (GPa) | characteristic |
| (1) | UBMS | a-C: H | 37 | Δ |
| (2) | (Unbalanced magnetron | | 23 | ∘ |
| | sputtering) | | | |
| (3) | UMBS + P-CVD | a-C: H | 31 | ∘ |
| | (Plasma. Chemical | | | |
| | Vapor Deposition) | | | |
| (4) | Sputtering | WC/C | 17 | ∘ |
| (5) | AIP | ta-C | 124 | ∘ |
| | (Arc Ion. Plating) | | | |
| (6) | F-CVA | ta-C | 41 | ∘ |
| | (Filteres Cathodic | | | |
| | Vacuum Arc) | | | |

In the structure of the front surface treatment layer in FIG. 1, the iron-based sintered material of the base material 4 employs a chemical composition C: 0.25, Ni: 0.5, Mn: 0.2, and Mo: 0.5% (mass %), and a density 7.05 Mg/m³ The surface layer hardened by diffusion 3 forms a carbonization-quenched layer in accordance with a carbonization quenching treatment (900° C.) and a tempering treatment (180° C.), and its front surface is lapping processed so as to be finished such that a surface roughness becomes equal to or less than 0.5 μm. On the front surface, Cr is formed as the interlayer 2 in (1) to (3), WC/C is formed as the interlayer 2 on the Cr in (4), and Ti is formed as the interlayer 2 in (6). The interlayer 2 is not formed in (5). The diamond like carbon (DLC) coating sheet of the hard carbon coating 1 thereon is set to various kinds of membranes, and they are evaluated.

With regard to the surface hardness of the coating sheet, a hardness evaluation is carried out in accordance with a nano indentation method (ISO14577).

The hardness evaluation in accordance with the nano indentation method (ISO14577) is carried out under such a condition that a Berkovich triangular pyramid indenter having a vertically opposite angle 115 degree is pressed in a front surface of a coating sheet up to a maximum load 3 mN for ten seconds, and is maintained at the maximum load for one second, and a load is thereafter removed for ten seconds.

Table 1 indicates the hardness of the various DLC coating sheets.

The values indicate various values in accordance with the kind of the membranes. The hardness is 17 GPa and is the softest in (4), and is 124 GPa and is the hardest in (5). (4) is the soft DLC on the basis of a laminated structure of WC and C, and (5) comes to a hydrogen free and hard coating sheet. The other DLCs are distributed between both of them, and are between 23 and 41 GPa.

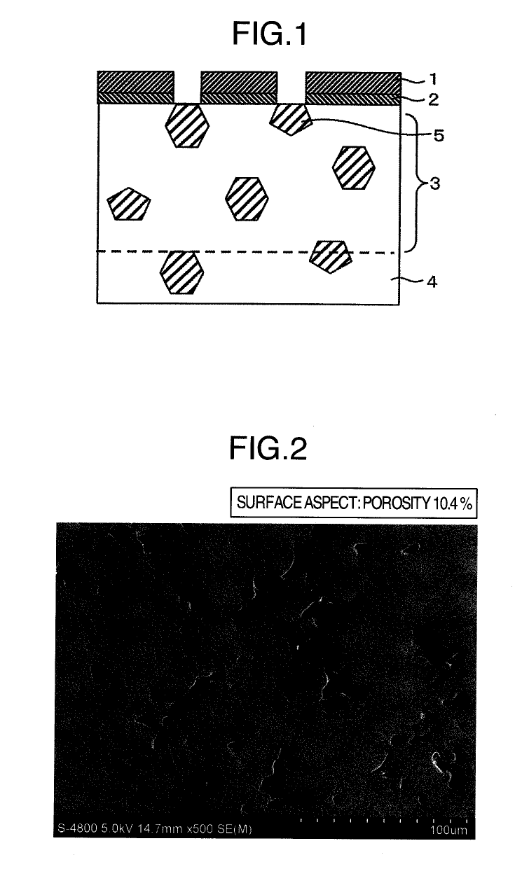

FIG. 2 shows a surface aspect of the iron-based sintered material to which the DLC coating is applied in (3). Viewing the drawing, it is known that the pore of the base material existing before the DLC coating is formed as the open aspect even after the DLC coating, and the DLC coating sheet comes to a discontinuous surface layer in the pore portion. The porosity of this surface comes to 10.4%. The porosity is calculated by identifying the aspect photograph of the front surface by an image processing software in a personal computer such that the base material surface is a white color and the pore portion is a black color, and calculated on the basis of an area ratio. Since the porosity of the base material is 10.5% on calculation (7.88-7.05/7.88 because a true density on calculation is 7.88 Mg/m³, and a density of a sample material is 7.05 Mg/m³), it is known that the porosity after the DLC coating is hardly changed. Accordingly, it is desirable that the porosity after the DLC coating maintains the porosity of the base material.

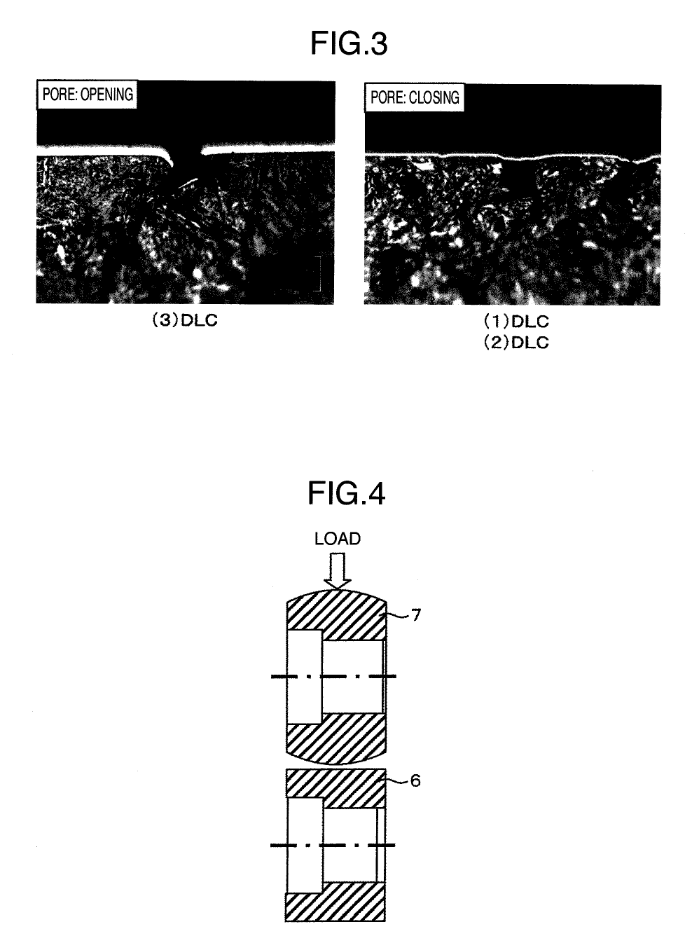

FIG. 3 shows a cross sectional structure aspect of the iron-based sintered material to which the DLC coating is applied. Viewing FIG. 3, it is known that in the iron-based sintered material of the DLC coating in (3), the DLC on the most front surface seen as a gray and the Cr and WC/C coating sheet of the interlayer seen as a white are not formed in the pore portion, but the pore is open, and the DLC coating sheet comes to a discontinuous surface layer in the pore portion. In this case, in the iron-based sintered materials of the DLC coatings in (4) to (6), the similar cross sectional structure aspect shows.

On the other hand, it is known that in the iron-based sintered materials of the DLC coatings in (1) and (2), the DLC on the most front surface seen as the gray and the Cr coating sheet of the interlayer seen as the white are formed in the pore portion, the pore is closed, and the DLC coating sheet comes to a continuous surface layer in the pore portion. The aspect mentioned above is not seen in all the pore portions, but is scattered. In the pore portion of the cross sectional structure aspect mentioned above, the pore is closed by the hard carbon coating and the interlayer, an intrusion of the lubricating oil is obstructed, and the oil keeping effect is deteriorated.

In accordance with this matter, the DLC of the slide member of the iron-based sintered material in accordance with the present invention desirably employs a membrane forming method which can maintain the pore of the base material after the DLC coating, and a plasma CVD is suitable in the membrane forming step of the diamond like carbon.

As a characteristic of the slide member of the iron-based sintered material showing the hardness characteristic, the surface aspect and the cross sectional structure aspect mentioned above, a rolling contact fatigue strength is evaluated.

If the rolling contact fatigue strength is exposed to a repeated stress, the material brings on a pitching (a peeling phenomenon) in a maximum shear stress portion at certain stress and repeating number. This is evaluated and compared by defining a stress first generating a pitching at the repeating number 1×10⁷ as a rolling contact fatigue strength of the material, in the rolling pitching test.

FIG. 4 shows an outline of the roller pitching test evaluating the rolling contact fatigue strength. Material to be evaluated: the iron-based sintered material 6 in accordance with the present invention is a smooth surface having an outer diameter 30 mm and an inner diameter 20 mm, and the other member 7 is a curved surface of 20R having an outer diameter 36 mm and an inner diameter 20 mm. The roller pitching test is carried out by dripping an ATF oil in a room temperature, rotating the material to be evaluated: the iron-based sintered material 6 in accordance with the present invention at 900 rpm and the other member 7 at 1200 rpm, and applying a slip of 60%. In this case, the other member 7 of the test piece employs a quenched material (60 to 62 HRC) of a high carbon chromic bearing steel (SUJ2).

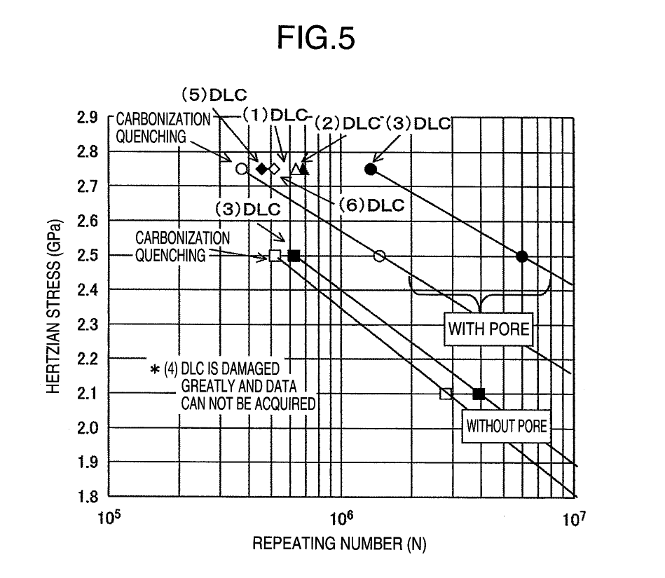

FIG. 5 shows the rolling contact fatigue strength of the iron-based sintered material coated with the various DLCs. Viewing the fatigue strength, a Hertzian stress at 1×10⁷ from the rolling contact fatigue strength in the case that the pore exists while keeping the carbonization quenched state indicates about 2.1 GPa, and on the contrary, the Hertzian stress at 1×10⁷ of the DLC coating in (3) indicates 2.4 GPa, and the rolling contact fatigue strength is improved. This means that a density conversion comes to 7.3 Mg/m³ in the DLC coating material in (3) with respect to 7.05 Mg/m³ in the carbonization quenched state, and an effect that the density is increased by the DLC coating appears. On the other hand, in the case that the pore does not exist, an improvement of the high rolling contact fatigue strength of the DLC coating material in (3) with respect to the carbonization quenched state is a little, and an influence of the pore remarkably appears. From this fact, it is known to be important that the pore exists on the surface of the DLC coating material.

Further, viewing the rolling contact fatigue strengths of the various DLC materials, in the case (4) that the DLC hardness is low, it is impossible to acquire the data due to a wastage caused by the abrasion of the DLC coating material. On the other hand, in the DLC in (5) and (6) having the high hardness, the abrasion is generated by attacking the other member, and the improvement of the rolling contact fatigue strength is not remarkable. From this fact, it is preferable that the hardness of the surface of the coating sheet is equal to or more than 23 GPa for suppressing the abrasion of the DLC layer in the slide motion with the other member, and it is preferable that it is equal to or less than 41 GPa for suppressing the abrasion of the other member.

The iron-based sintered material in accordance with the present invention is structured such as to improve the rolling contact fatigue strength, and is preferable for the iron-based sintered member which is used in such the environment that the lubricating oil is sufficiently fed, such as the automotive machine parts such as the various gears and sprockets (chain sprockets), the various industrial machine parts such as the rotor and the vane of the oil pump, and the like.

It should be further understood by those skilled in the art that the foregoing description has been made on embodiments of the invention and that various changes and modifications may be made in the invention without departing from the spirit of the invention and the scope of the appended claims.

1. An iron-based sintered material used in such an environment that a lubricating oil is sufficiently fed, wherein a hard carbon coating is provided on a surface of a base material constructed by an iron-based sintered material alloy having a pore via a surface layer hardened by diffusion and an interlayer, and a part of said pore is not covered with said surface layer hardened by diffusion, the interlayer and the hard carbon coating, but is formed in a state of being open to the surface of said surface layer hardened by diffusion.

2. An iron-based sintered material as claimed in claim 1, wherein said hard carbon coating has an indentation hardness between 23 and 41 GPa.

3. An iron-based sintered material as claimed in claim 1, wherein a porosity of the surface of said hard carbon coating is between 5 and 15%.

4. An iron-based sintered material as claimed in claim 1, wherein said hard carbon coating is constructed by a DLC.

5. An iron-based sintered material as claimed in claim 1, wherein said interlayer is at least one kind selected from Si, Cr, Ti, W, TiC and WC.

6. An iron-based sintered material as claimed in claim 1, wherein said surface layer hardened by diffusion is constructed by any one of a carbonization-quenched layer, a nitride layer, a nitrocarburized layer and a carburized nitride layer.
